(19) United States
(12) Patent Application Publication
(10) Pub. No.: US 2003/0051755 A1
(43) Pub. Date: Mar. 20, 2003

(54) Fluid pressure-reducing valve with a rotary hand wheel having a limited angular travel

(76) Inventors: Gilles Cannet, Parmain (FR); Philippe Pisot, Presles (FR); Marco Arzenton, Verone (IT); Silvano Bendazzoli, Verone (IT); Daniel Roy, Marles En Brie (FR); Etienne Gounot, Paris (FR)

Correspondence Address: YOUNG & THOMPSON, 745 SOUTH 23RD STREET 2ND FLOOR, ARLINGTON, VA, 22202

(21) Appl. No.: 09/876,136

(22) Filed: Jun. 8, 2001

(30) Foreign Application Priority Data
Jun. 8, 2000 (FR) 0007353

(51) Int. Cl. G05D 16/06

(52) U.S. Cl. 137/505.38

(57) ABSTRACT

A fluid pressure-reducing unit or pressure-reducing valve allowing the pressure or flow rate of a fluid to be controlled or adjusted, including a main body within which at least one internal fluid passage is made between at least one fluid inlet orifice and at least one fluid outlet orifice, a part for controlling the fluid pressure and/or flow rate being arranged in or on at least part of the internal fluid passage, and at least one operator-operable rotary hand wheel part cooperating with the fluid pressure and/or flow rate control part, in response to the rotary hand wheel part being rotated, so as to control or adjust the pressure and/or the flow rate of the fluid flowing through the internal fluid passage and leaving via the fluid outlet orifice, wherein the rotary hand wheel parts can move in terms of rotation into a number of distinct angular positions, each angular position corresponding to a given fliud pressure or flow rate value, and the rotary hand wheel part having an angular travel less than 340°.

A fluid pressure-reducing unit or pressure-reducing valve allowing the pressure or flow rate of a fluid to be controlled or adjusted, comprising a main body (100) within which at least one internal fluid passage (160) is made between at least one fluid inlet orifice (130) and at least one fluid outlet orifice, means for controlling the fluid pressure and/or flow rate being arranged in or on at least part of said internal fluid passage (160), and at least one operator-operable rotary hand wheel means (110) cooperating with said fluid pressure and/or flow rate control means, in response to said rotary hand wheel means (110) being rotated, so as to control or adjust the pressure and/or the flow rate of the fluid flowing through said internal fluid passage (160) and leaving via said fluid outlet orifice, wherein said rotary hand wheel means (110) can move in terms of rotation into a number of distinct angular positions, each angular position corresponding to a given fluid pressure or flow rate value, and said rotary hand wheel means (110) having an angular travel less than 355°, preferably between 300° and 350°.

The invention relates to an integrated pressure-reducing unit or pressure-reducing valve with adjustable pressure or flow rate that is economical, robust and easy to use and maintain for gas cylinders, particularly intended for gas cylinders that can be used in the field of welding, in laboratories or the like.

Numerous types of integrated pressure-reducers and pressure-reducing valves are known, and reference may, for example, be made to document EP-A-0747796. The most sophisticated offer the functions of adjusting the reduced pressure, reading of the high pressure and the reduced pressure on pressure gages, preventing the return of gas, retaining pressure, quick connection, etc. The simplest ones offer non-adjustable pressure reduction and no means of reading the reduced pressure because this is, by definition, fixed.

Other gas regulator and/or pressure reducing devices are described in documents FR-A-2447573, EP-A-959293 and U.S. Pat. No. 3,776,412.

It is also known that pressure reducers can be used as flow generators: by equipping their outlet circuit with a calibrated orifice, a determined relationship is obtained between the pressure downstream of this orifice, that is to say the reduced pressure, and the flow rate, provided that limits on the pressure drop in the gas user circuit are observed. For example, it is known that provided the flow generated through the calibrated orifice is sonic, the relationship tying the generating pressure to the flow rate is a linear one. Sonic flow can be ensured by adhering to a ratio of 2 (1.8 for air) between the absolute pressure at the inlet to the orifice and the absolute pressure at its outlet. Thus, in the text which follows, mention is often made to the adjusting of the flow rate as an alternative to adjusting the pressure, for example.

The most sophisticated apparatuses are also the bulkiest and the most complicated to maintain because of the number of components involved. They are perfectly suited to large cylinders and fit neatly inside the envelope defined by the diameter of the barrel of the cylinders, their mass is negligible compared with the mass of the cylinders on which they are fitted and, furthermore, these cylinders travel less often than small cylinders, are moved around using carriages and are generally used by experienced/adept operators.

A problem has arisen particularly with small-capacity cylinders, that is to say ones able to contain from 0.5 to 12 liters (geometric volume), and this problem is one of giving all the convenience of use to a pressure reducer or to an integrated pressure-reducing valve assembly which is not too bulky, is robust, is economical, and is easy to maintain and to use, in the knowledge that small cylinders are often transported and, as a result, more exposed to knocks and vibrations, and in the knowledge also that, because of their small size, they expose their valve even more to dirt and spraying associated with their use, for example being sprayed with hot particles of metal or oxide in the case of welding or cutting for example.

One of the trickiest aspects of pressure reducers and integrated pressure-reducing valve assemblies, is the pressure gage that measures the reduced pressure, because this needs to be very sensitive in order to provide usable information, and very robust in order not to be damaged and therefore made to give false readings by knocks and vibrations. However, in order to be effective, a conventional pressure gage for example uses a Bourdon tube which is easily deformable and therefore sensitive also to knocks and great amplitude of movement, and therefore undesirable deformations, these being two characteristics which contribute to delicacy.

However, in known integrated pressure reducers and pressure-reducing valve assemblies, this pressure gage is the only way of determining what the pressure actually delivered is.

Furthermore, this pressure gage occupies a not insignificant amount of space.

The problem has therefore arisen either of strengthening the gage, although this incurs cost, and of reducing it size, although this reduces the precision with which it can be read, or of finding some other reading means.

It is known practice in pressure reducers for the travel of the adjusting screw of the pressure reducer to be graduated using a kind of vernier gage which has the merit of appearing to be accurate but it is rather inconvenient to use, yielding reading errors of the parallax type and being rather time consuming to operate over a number of screw turns.

The maintenance problems that arise with integrated pressure reducers and pressure-reducing valve assemblies are often concentrated on the pressure gages, particularly the gage that measures the reduced pressure, because this is the more sensitive and therefore more delicate one. Solutions for making this easier to fit and to change, and for increasing its robustness have been proposed in EP-A-747796, but their purchase cost remains high and replacing them entails apparatus down-time.

Another component that is at the heart of maintenance complications is the adjusting screw.

In order to render it captive and to limit its travel, so that a limit pressure cannot be exceeded, known screws are secured to the pressure-reducing “bonnet” and replacing them, should they become worn or damage, entails almost completely dismantling the pressure reducer, with the risk of contamination or of reassembly error that cannot be neglected, and with an adjusting procedure that requires means generally reserved for factories in which integrated pressure reducers or pressure-reducing valve assemblies are assembled, hence entailing a requirement of returning the apparatus to the manufacturer.

A partial solution, but one which is not entirely satisfactory, is described in document U.S. Pat. No. 3,699,998, which discloses an easily removable and calibrated pressure regulator. With such a device, it is no longer necessary to use a pressure gage or some other pressure indicator because the rotary hand wheel with which it is equipped is indexed and has an angular travel limited to 360° by the presence of travel-limiting pegs.

However, with this device which is operated over 1 turn, that is to say 360°, the problem still posed is that an operator may have difficulty in understanding whether the valve is set to its maximum position or to its minimum position because these two positions coincide, this leading to a not insignificant safety problem.

In addition, a parallax error may creep into the reading by the operator of the indications borne by the device.

Moreover, having to operate the hand wheel over a complete turn is not a practical thing for the operator to do.

Furthermore, an operating hand wheel produced on an industrial scale, and therefore with tolerances, then mounted on a pressure-reducing valve assembly, never falls exactly into the same angular position on assembly, this phenomenon being further amplified in use, with the wear and hammering of the various components and may result in the fact that, at the end of the travel, the minimum adjustment mark unintentionally falls opposite the adjustment indicator even though the hand wheel is in actual fact screwed into its maximum adjustment position.

The object of the present invention is therefore to solve the above problems by proposing an improved integrated pressure reducer or pressure-reducing valve assembly, that is to say which allows easier operation by the operator while at the same time alleviating the problems that exist with the known devices, particularly the device known from document U.S. Pat. No. 3,699,998.

The solution of the invention therefore consists in an integrated fluid pressure-reducing unit or pressure-reducing valve assembly allowing the pressure or flow rate of a fluid to be controlled or adjusted, comprising a main body within which at least one internal fluid passage is made between at least one fluid inlet orifice, via which a fluid enters at high pressure, and at least one fluid outlet orifice, via which the fluid exits at a low pressure lower than said high pressure; means for controlling the fluid pressure and/or flow rate being arranged in or on at least part of said internal fluid passage so as to allow control over the flow rate and/or the pressure of the fluid flowing in said internal passage between said inlet and outlet orifices; and at least one operator-operable rotary hand wheel means cooperating with said fluid pressure and/or flow rate control means, in response to said rotary hand wheel means being rotated, so as to control or adjust the pressure and/or the flow rate of the fluid flowing through said internal fluid passage and leaving via said fluid outlet orifice.

According to the invention, said rotary hand wheel means can move in terms of rotation into a number of distinct angular positions, each angular position corresponding to a given fluid pressure or flow rate value, and said rotary hand wheel means having an angular travel less than or equal to 350°, preferably less than or equal to 345°.

The unit or assembly or the invention may, as the case may be, have one or more of the following features:

the fluid pressure or flow rate control means comprise a pressure-reducing screw or a cam acting on at least one valve shutter, via a spring,

the pressure-reducing screw has at least one thread,

the pressure-reducing screw has a multi-start thread,

the diameter of the rotary hand wheel is at least 50 mm,

the rotary hand wheel means comprises one or more travel-limiting stops, preferably the stops are arranged on the inside of the rotary hand wheel,

the rotary hand wheel means is made of a molded polymer material,

the angular travel of the rotary hand wheel is less than or equal to 345°, and preferably, less than or equal to 340°,

the angular travel of the rotary hand wheel is greater than or equal to 250°, preferably greater than or equal to 280°, and more preferably still, greater than or equal to 300°,

the angular travel of the rotary hand wheel is between 305° and 335°, preferably of the order of 310° to 325°,

the fluid pressure or flow rate control means further comprise at least one valve shutter and/or at least one spring,

it further comprises a moving lever operable by the operator, for example a rotary lever, between at least one position open to the flow of fluid and at least one position closed to the flow of fluid, said lever acting on a valve shutter making it possible to allow or prevent the passage of fluid through at least one passage of the main body.

The invention also relates to a container for fluid under pressure, particularly a gas cylinder, equipped with a pressure-reducing unit or pressure-reducing valve according to the invention, preferably said unit is inserted into and protected by a protective bonnet mounted on the container.

In practice, the solution of the invention is that of proposing a pressure-reducing or pressure-reducing valve, the operation of which is explained hereinafter in conjunction with the appended figures, among which:

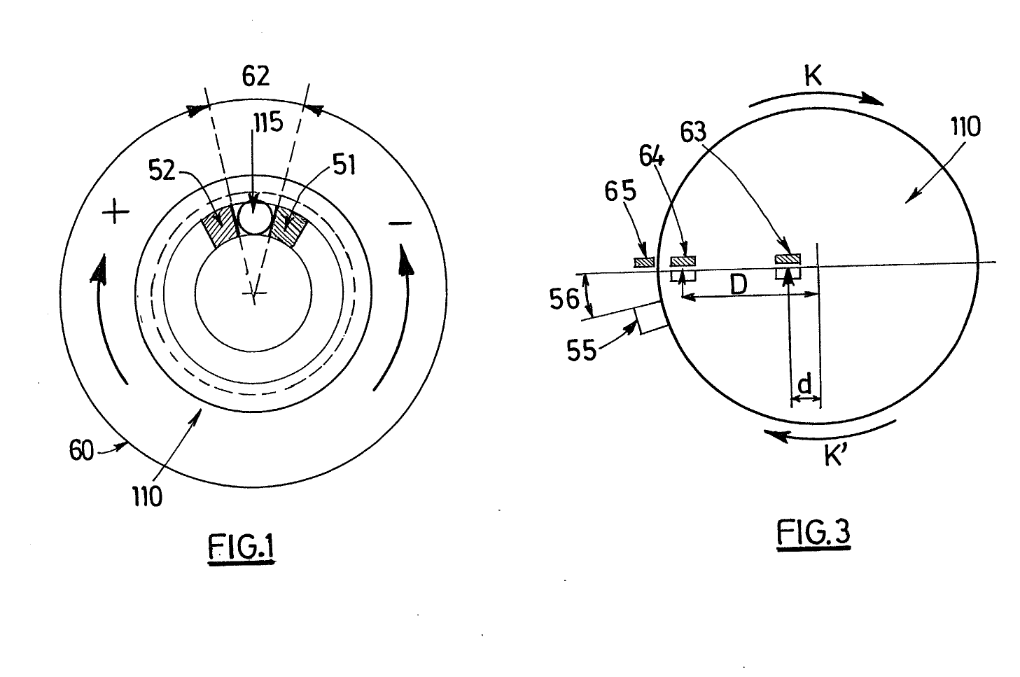

FIG. 1 shows the travel of the hand wheel of a unit according to the invention,

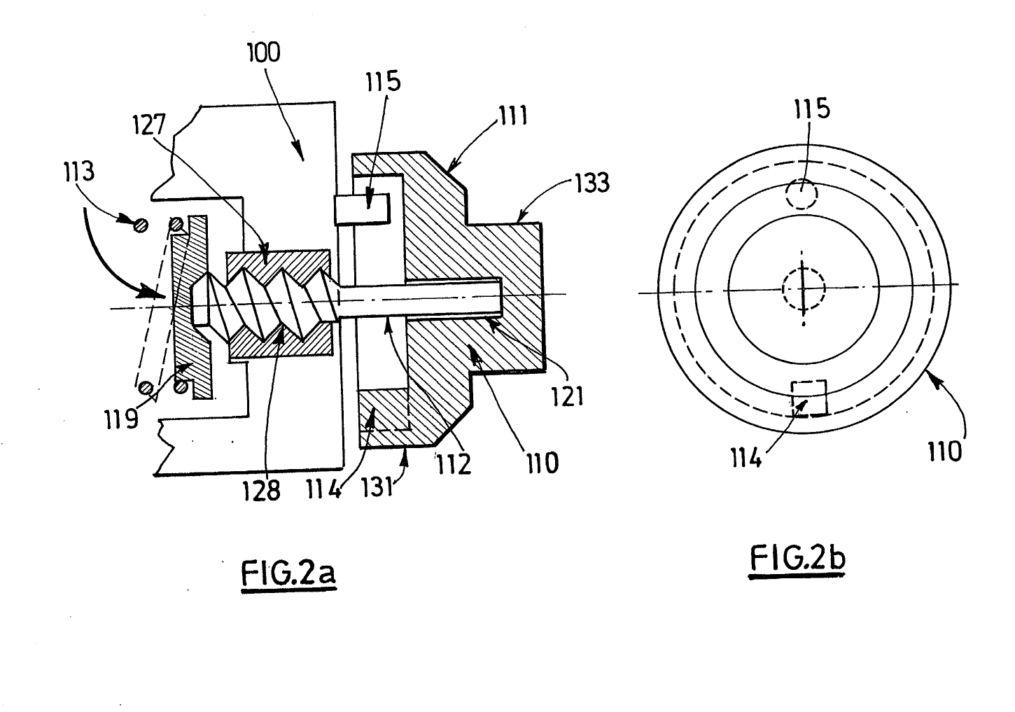

FIGS. 2a and 2b schematically depict the operation of a unit according to the invention, particularly the interaction between hand wheel and the parts of the body located under the hand wheel;

FIG. 3 proposes an alternative form to FIGS. 1, 2a and 2b;

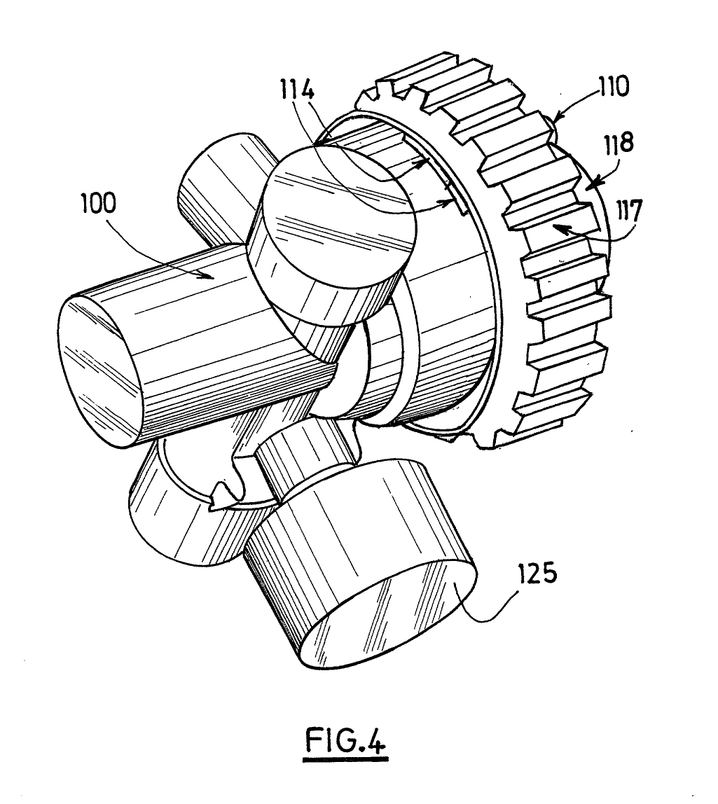

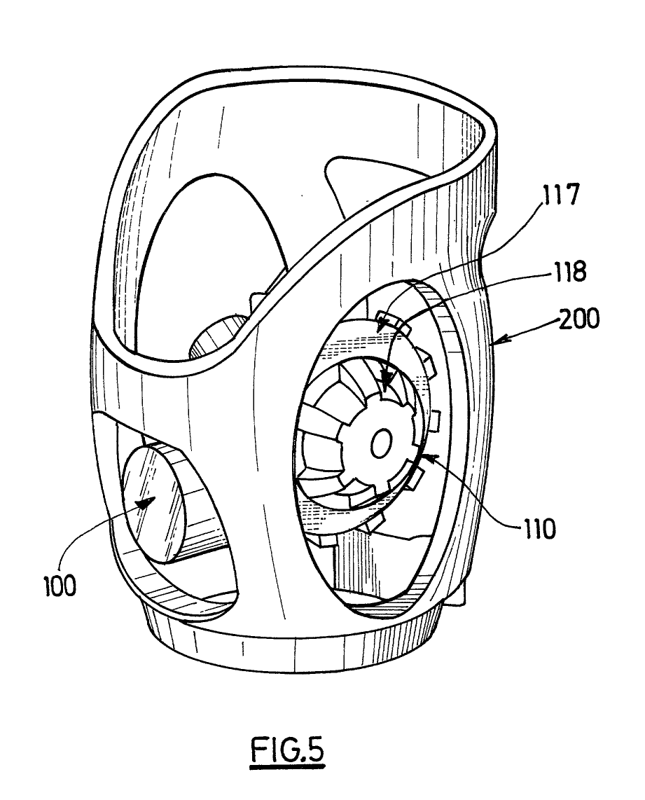

FIG. 4 shows an elevation of a pressure-reducing valve unit according to the invention;

FIG. 5 shows the unit of FIG. 4 inserted in a protective bonnet;

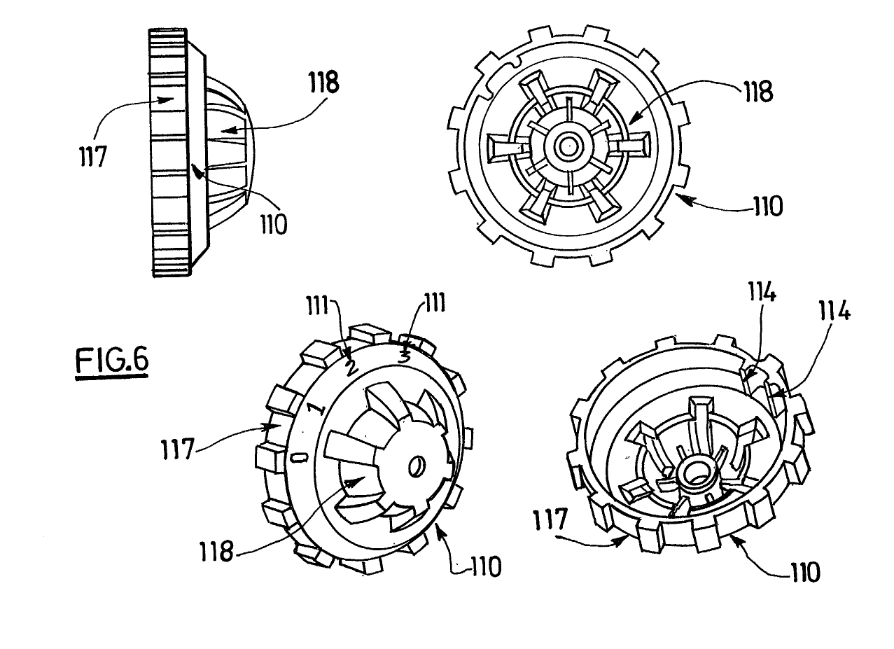

FIG. 6 shows various views of the rotary hand wheel of a unit according to the invention;

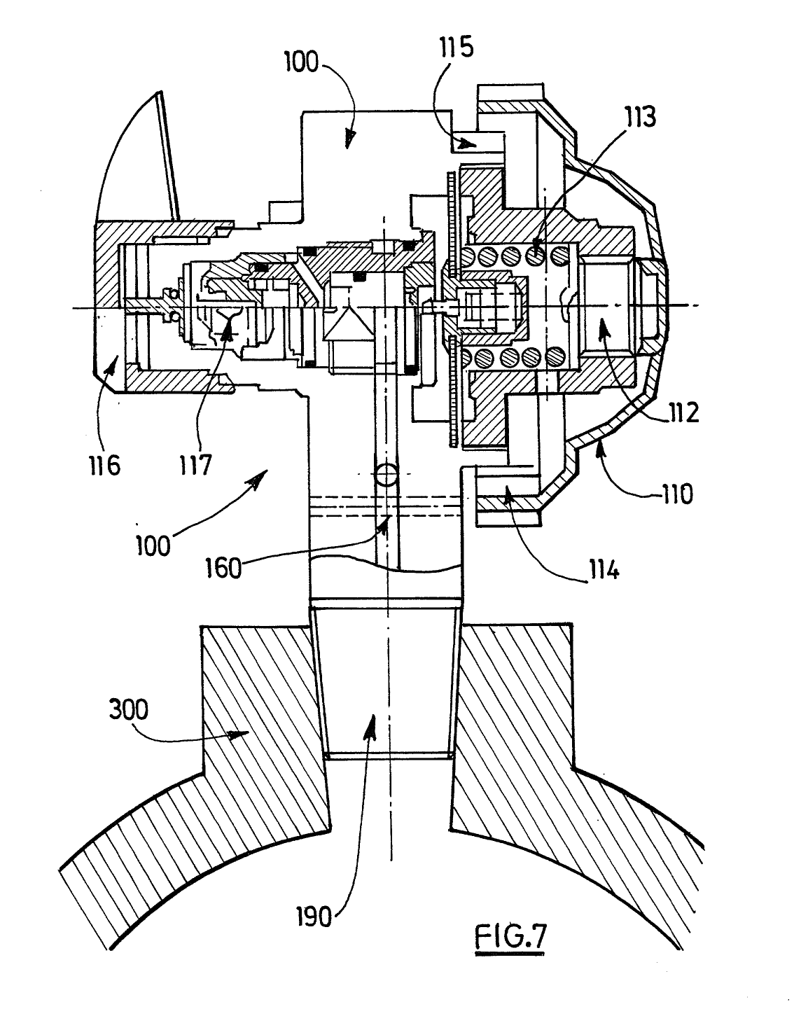

FIG. 7 is a detailed sectional view of a pressure-reducing valve unit according to the invention, and

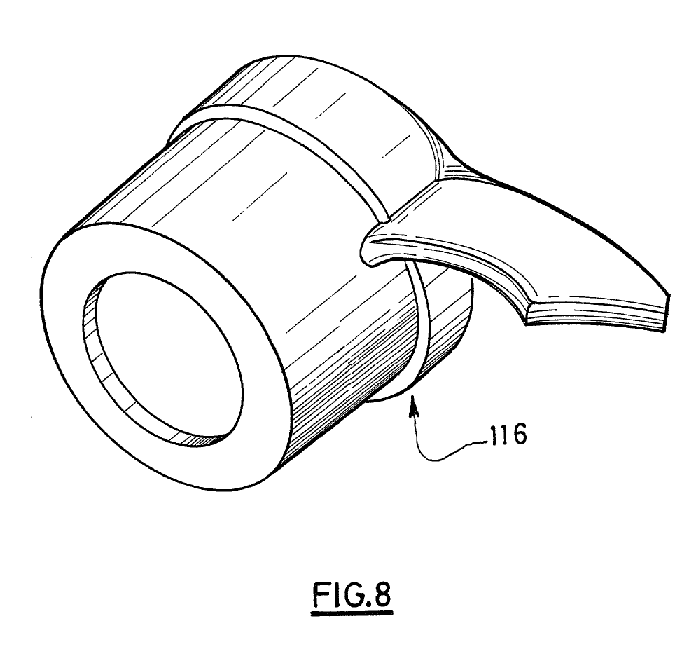

FIG. 8 is a view of the lever 116 of FIG. 7.

According to the invention, the fluid pressure or flow rate are adjusted using a graduated 111 hand wheel 110 which causes a flow rate or pressure value to correspond to each angular position 111. Useful travel of this hand wheel 110 is markedly less than one turn (360°), that is to say less than 350°, in order to avoid any possible confusion to within one or more turns.

A pressure-reducing screw 112 located in the body 100 of the unit is defined according to this constraint of limiting the travel to under one turn and, for example, the screw is a multi-start screw. As an alternative, the pressure-reducing screw 112 may be replaced by a cam.

Furthermore, the hand wheel 110 is dimensioned in such a way that the screw 112 may be easy to operate, that is to say that it has a diameter that is large enough, for example greater than 50 mm, for the torque needed to stress the pressure-reducing spring 113 can be transmitted to the screw 112 without difficulty. A large pressure-reducing hand wheel 110 offers a large area on which to engrave clearly legible marks 111 or figures. As a preference, the surface bearing the etchings 111, marks or figures is at an angle with respect to the axis of rotation of the hand wheel 110, because this particular arrangement offers the advantage that the marks and figures 111 can be read off the top or off the side of the hand wheel with equal ease, something which is important in the case of small gas cylinders equipped with this unit.

Travel-limiting stops 114 are located on the hand wheel 110 itself, which makes it possible to offer good resistance to the high forces that the hand wheel 110 experiences, because of its large diameter, when operated. As a preference, these stops 114 are located on the inside of the hand wheel 110, which eliminates the risk of the operator having his hand trapped between the stops 114 on the hand wheel and the stops 115 on the body 100. This particular arrangement also leads to a simpler mold design if the hand wheel 110 is produced by molding. Finally, this arrangement affords an esthetic benefit by forming a hand wheel 110 whose exterior surface is symmetric about its axis of rotation.

Pressure-reducing springs 113 and calibrated valve shutters are used in order to obtain a constant law governing the variation in pressure as a function of the travel of the hand wheel 110, from one apparatus to another. The dimensional tolerances on the other components, particularly the dimensions involved in the string of dimensions aligned with the axis of the pressure-reducing valve shutter are not critical from the point of view of adjustment precision because clearances can be taken up simply upon assembly, as described hereinbelow.

In order to obtain an optimum result, the integrated pressure-reducing valve assembly of the invention can be fitted and calibrated as follows:

once the integrated pressure-reducing valve assembly has been assembled, it is then supplied with gas via its high-pressure circuit of the body 1 comprising the gas inlet orifice 130;

the pressure-reducing screw 112 is then adjusted so as to obtain a reference pressure value R corresponding, for example, to the middle of the travel of the hand wheel 110, using a pressure gage, under standardized operating conditions (upstream pressure, downstream pressure drop and flow rate using a calibration gas);

the graduated adjusting hand wheel 110 is attached and secured to the adjusting screw 112 in such a way that the graduation corresponding to the reference value R lies facing the adjusting mark.

The adjusting hand wheel 110 can be replaced during maintenance of an apparatus designed and produced according to the description hereinabove by repeating the same simple procedures as were used in fitting.

The design of an integrated pressure-reducing valve according to the invention with a graduated 111 hand wheel 110 affords the advantage that the flow rate or pressure can be adjusted before gas is made to flow from the cylinder 300 to its point of use. Conventional devices do not allow this, and the result is a tendency for users not to alter the settings of their pressure-reducer at the end of use in order not to have to adjust it again for the next use. This practice is damaging to the pressure reducer because the pressure-reducing spring and the pressure-reducing valve shutter remain constantly under stress and their characteristics may drift over time. The possibility of presetting the pressure reducer by virtue of its graduated hand wheel may also cause this type of screw and hand wheel to be adopted for apparatuses equipped with a reduced-pressure pressure gage.

One exemplary embodiment of an integrated pressure-reducing valve according to the invention is illustrated in FIGS. 7 and 8. This integrated pressure-reducing valve is made up of a body 100 accommodating an on-off means that can be operated by a quarter-turn lever 116 (see FIG. 8) which allows the flow to be opened or closed and makes it possible to tell whether the cylinder 300 is open or closed at first glance and which is simple and quick to operate both in terms of opening and in terms of closing. This system consists of a valve shutter 117, the translation movement of which is brought about by turning the secured lever 116, itself secured to a helical ramp which screws into or unscrews from the body 100 of the integrated pressure-reducing valve assembly.

Furthermore, the body comprises a pressure reducer that can be adjusted by the twin-start adjusting screw 112 allowing the pressure to be adjusted between the maximum value (4 bar in the case of the oxygen version and 1.3 bar in the case of the acetylene version, for example) and the minimum value which is here chosen to be zero, in under one turn, that is to say in under 360°, for example in the order of 310 to 315°. Said screw 112 is operated manually using the hand wheel 110 which is graduated 111 explicitly in terms of pressure (or in terms of flow rate) and attached to the assembly by nesting on said adjusting screw 112. The limits on the adjusting travel are obtained by means of stops 114 situated at the periphery of the hand wheel 110 itself so that a limited force, in any event amplified by the hand wheel 110, is transmitted to them. The screw 112 has no rotational limitations because stops 114 may be subjected to high torque, particularly with this large-diameter hand wheel 110 required for effortless adjustment and may thus become worn or hammered, which would lead to adjustment drift. The hand wheel 110 of this unit has been designed to be able to be operated, either by accessing, on the side of the bonnet 200 of the cylinder 300, the 6 crenelations 118 in which a thumb can engage, the index and middle finger forming a strong triple grip (cf. FIGS. 4 to 6); or by accessing from the top of the bonnet 200, the middle finger for example being able to push on the 12 crenelations 117 placed at the periphery of the hand wheel 110.

A pressure gage 125 measures the high pressure, that is to say the remaining autonomy of the cylinder 300.

The assembly is preferably housed under the bonnet 200 of the cylinder 300 which is intended to protect it from knocks and to make the cylinder 300 thus equipped easier to transport.

Stated another way, the solution of the invention consists in establishing a relationship between graduations inscribed on the adjusting hand wheel and the pressure (or the flow rate) delivered by the apparatus, that is to say that by bringing the desired graduation to face an adjusting mark formed on the body or any other fixed part, the desired pressure or flow rate is obtained. For obvious safety reasons, the hand wheel is captive and limited in terms of travel in order to confine the pressure and/or flow rate provided by the apparatus, but can be changed simply without dismantling the pressure reducer and its fitting requires only simple means available in any maintenance department.

The invention applies to all pressure reducers and pressure-reducing valves with pressure or flow rate adjustment irrespective of their field of use, for example in the field of welding, foodstuffs, laboratories, etc.

FIGS. 1, 2a, 2b and 3 schematically illustrate the principle of operation of a pressure-reducing valve unit according to the present invention.

FIG. 2a schematically illustrates a pressure reducer or pressure-reducing valve body 100 equipped with a hand wheel 110 for adjusting the pressure or flow rate of the fluid flowing in this body 100, said hand wheel 110 acting on an intermediate plate 119 between the pressure-reducing screw 112 and the pressure-reducing spring 113. The pressure-reducing screw 112 is fixed or nested in the hand wheel 110 at a zone of insertion 121 via one of its ends. Via its other end, the pressure-reducing screw 112 collaborates with the plate 119, said screw 112 comprising a thread or ramp 128 collaborating with a reciprocal thread or ramp 127 of the body 100 so as to convert the rotational movement of the hand wheel 110 into a translational movement toward or away from the plate 119.

A stop 115 secured to the body 100 is situated under the hand wheel 110, while another stop 114 secured to the hand wheel 110 is situated at the internal periphery of said hand wheel 110.

The hand wheel 110 moreover comprises a projecting part 133 so that the operator can operate it from the side, and a zone 131 for operating it from the top, when the unit is inserted in a protective bonnet as shown in FIG. 5.

Furthermore, FIG. 1 shows a schematic front view of the hand wheel 110, providing a visual depiction of its rotational travel 60 over less than 350°, preferably less than 340°. The position 51 corresponds to the position occupied by the stop 114 at the end of travel 60 after rotation in the negative direction (−), while the position 52 corresponds to the position occupied by the stop 114 at the end of travel 60 after rotation in the positive direction (+). As will be understood, the travel 60 of the hand wheel 110 is restricted to under 350°, typically to about 310° to 320°, which means that one pressure (or flow rate) setting and one alone corresponds to each angular position. In fact, the travel 60 is limited to 360°, from which the angle 62 between the positions 51 and 52 have to be subtracted.

FIG. 3 aims to explain, in theory, the operation of the hand wheel 110 being turned over less than one turn (360°).

In the light of this FIG. 3, it will be understood that the torque KK′ applied to the hand wheel 110 generates force on the stop, which force is higher, the closer the stop is located to the axis about which the hand wheel rotates.

Thus, for a stop 63 located at the distance “d”, the force is “E”; for a stop 64 located at a distance “D”, the force is “e” with e/E=D/d. The force could have been reduced a bit further with a stop 65 secured to the body and a stop 55 secured to the hand wheel both located outside the hand wheel, but for esthetic reasons and above all for ergonomic reasons, this solution, which incurs the risk of hands becoming trapped in the space 56, is less satisfactory than those proposed in the other figures.

The present invention therefore offers several advantages over the known devices, particularly an ease of operation because the angular travel of the hand wheel is limited to less than one turn, that is to say markedly less than 360°, which makes it possible to eliminate the risks of parallax error, of confusion between the maximum setting and minimum setting positions and makes the hand wheel easier for the operator to operate.

It is also to be emphasized that choosing excessively restricted angular travels for the hand wheel, for example over 180° or less, leads to a great reduction in the sensitivity and precision of the adjustment.

In addition, for a pressure-reducing unit, the shorter the adjustment, the greater the pitch of the pressure-reducing screw will have to be and therefore the higher the adjusting torque will be and, in extreme cases, given the desired broad range of adjustment, the adjustment could become self-reversing, that is to say that the adjusting screw could return to zero all by itself or under the effect of the slightest vibration or thermal expansion, and the adjustment will no longer be stable.

According to the invention, the rotary hand wheel means (110) preferably has an angular travel less than 355° but greater than or equal to 250°.

1. A fluid pressure-reducing unit or pressure-reducing valve allowing the pressure or flow rate of a fluid to be controlled or adjusted, comprising a main body within which at least one internal fluid passage is made between at least one fluid inlet orifice and at least one fluid outlet orifice, means for controlling the fluid pressure and/or flow rate being arranged in or on at least part of said internal fluid passage, and at least one operator-operable rotary hand wheel means cooperating with said fluid pressure and/or flow rate control means, in response to said rotary hand wheel means being rotated, so as to control or adjust the pressure and/or the flow rate of the fluid flowing through said internal fluid passage and leaving via said fluid outlet orifice, wherein said rotary hand wheel means can move in terms of rotation into a number of distinct angular positions, each angular position corresponding to a given fluid pressure or flow rate value, and said rotary hand wheel means having an angular travel less than 355°.

2. The unit as claimed in claim 1, wherein said fluid pressure or flow rate control means comprise a pressure-reducing screw or a cam acting on at least one valve shutter.

3. The unit as claimed in claim 1 or 2, wherein the pressure-reducing screw has at least one thread.

4. The unit as claimed in claims 1 to 3, wherein the pressure-reducing screw has a multi-start thread.

5. The unit as claimed in claims 1 to 4, wherein the diameter of the rotary hand wheel is at least 50 mm.

6. The unit as claimed in claims 1 to 5, wherein the rotary hand wheel means comprises one or more travel-limiting stops, preferably the stops are arranged on the inside of the rotary hand wheel.

7. The unit as claimed in claims 1 to 6, wherein the rotary hand wheel means is made of a molded polymer material.

8. The unit as claimed in claims 1 to 7, wherein the angular travel of the rotary hand wheel is less than or equal to 350°, preferably less than or equal to 345°, and more preferably still, less than or equal to 340°.

9. The unit as claimed in one of claims 1 to 8, wherein the angular travel of the rotary hand wheel is greater than or equal to 250°, preferably greater than or equal to 280°, and more preferably still, greater than or equal to 300°.

10. The unit as claimed in one of claims 1 to 9, wherein the angular travel of the rotary hand wheel is between 305° and 335°, preferably of the order of 310° to 325°.

11. The unit as claimed in one of claims 1 to 10, wherein the fluid pressure or flow rate control means further comprise at least one valve shutter and/or at least one spring.

12. The unit as claimed in one of claims 1 to 11, and which further comprises a moving lever operable by the operator between at least one position open to the flow of fluid and at least one position closed to the flow of fluid, said lever acting on a valve shutter making it possible to allow or prevent the passage of fluid through at least one passage of the main body.

13. A container for fluid under pressure, particularly a gas cylinder, equipped with a pressure-reducing unit or pressure-reducing valve as claimed in one of claims 1 to 12.

14. The container for fluid under pressure as claimed in claim 13, wherein the unit is protected by a protective bonnet mounted on the container.
